(19) United States
(12) Patent Application Publication
(10) Pub. No.: US 2004/0150135 A1
(43) Pub. Date: Aug. 5, 2004

(54) Method of melt-forming optical disk substrates

(76) Inventors: Michael Hennessey, South Lyon, MI (US); George Gutman, Birmingham, MI (US); David Strand, Bloomfield Twp, MI (US); Barry Clark, Ortonville, MI (US)

Correspondence Address: ENERGY CONVERSION DEVICES, INC., 2956 WATERVIEW DRIVE, ROCHESTER HILLS, MI, 48309, US

(21) Appl. No.: 10/465,250

(22) Filed: Jun. 19, 2003

Related U.S. Application Data
(63) Continuation-in-part of application No. 10/185,246, filed on Jun. 26, 2002.

(51) Int. Cl. B29C 59/02; B05D 5/00

(52) U.S. Cl. 264/293; 427/256

(57) ABSTRACT

The present invention provides a method for the continuous manufacturing of optical memory or optical memory substrates, and/or optical disks, which includes supplying a web of polymeric material between two mating platens, melt-forming at least one microform image, such as an information track structure for an optical device, into the web with a substantially flat stamper, heating a substantial portion of the melt formed cross section of the web of polymeric material to the melt flow temperature (T_{f}) of the polymeric material. The invention discloses several embodiments for melt-forming an information structure and depositing several layers onto information structure to produce an optical memory device.

### RELATED APPLICATION DATA

The present application is filed under 35 USC § 1.53(b) as a Continuation-in-Part of U.S. patent application Ser. No. 10/185,246, filed on Jun. 26, 2002, which is hereby incorporated herein by reference.

### FIELD OF THE INVENTION

The present invention relates to methods for making optical memory devices. More particularly, the present invention pertains to manufacturing optical disk substrates having, for example, patterns of pits-and-lands or grooves-and-lands. Further, the present invention relates to an apparatus and method for replicating patterns with an essentially flat stamper on thin preformed sheets of polymeric film (0.6 mm or less) for use within an optical memory system, while maintaining acceptable production throughput, reducing the effect of polymeric film manufacturing variability, reducing the unacceptably high perpendicular birefringence found in some cast polymeric films, and forming a centered hole through the replicated structure simultaneously in a single production step.

### BACKGROUND OF THE INVENTION

Optical memory disks, such as CD (compact disks), CD-R, CD-RW; DVD (digital versatile disks), DVD-R, DVD-ROM, DVD-RAM, DVD+RW, DVD−RW, PD (phase change disks) and MO (magneto optical), etc., are typically manufactured by initially forming a substrate and then depositing one or more thin film layers upon the substrate. Substrates for optical memory are usually formed with a series of grooves and/or pits arranged as concentric tracks or as a continuous spiral. The grooves and pits may be used for things such as laser beam tracking, address information, timing, error correction, user data, etc. Substrates used for optical disks are typically formed by injection molding, where a molten polymeric material is injected into a disk shaped mold with one surface having the patterned microstructure to be replicated. The patterned microstructure is typically provided by an exchangeable insert, commonly referred to as a stamper. The injection molding process is comprised of a series of precisely timed steps, which include closing the mold, injecting the molten polymer, providing a controlled reduction in peak injection pressure, cooling, center-hole formation, opening the mold and removing the replicated disk and associated sprue. Following the molding process, disk substrates are typically coated with one or more thin film layers. Thereafter, substrates may be coated with various insulating and/or protective layers, bonding adhesive, decorative artwork, labels, etc.

Although injection-molding methods, such as those described above, can provide high quality optical memory disks with acceptable levels of birefringence and flatness, the rate of disk production is only in the neighborhood of several seconds, as low as two seconds. About 60% of this time is attributable to the molding step, and the rest is taken up by the need to open the mold, remove the disk and sprue, and then close the mold before the next cycle can begin. Furthermore, present attempts to improve production rate by using various novel de-molding techniques or by using multi-cavity molds have had only limited success.

Besides lower than desired production rates, injection molding requires complex closed-loop control over numerous parameters. For example, mold and polymer temperature, press clamp force, injection profile and hold time all have competing and often-opposed influences on birefringence, flatness, and on the accuracy of the replicated features. It should also be noted that molding difficulty increases as the thickness of the replicated disk decreases. So where standard CD substrates, which are approximately 1.2 mm thick, do not require the use of specialized techniques, such as increasing the molding cavity cross-section during the main injection phase (injection-compression molding, coining, “bump molding”, etc.), standard DVD substrates, which are approximately 0.6 mm thick, do in order to simultaneously meet birefringence and flatness specifications.

Present DVD optical data storage drives use a red laser (λ 635-660 nm) and a final objective lens with a numerical aperture (NA) of 0.6. Some next generation systems propose using a blue laser (λ 405 nm) and a 0.85 NA final objective lens. These changes can result in a smaller focused spot size (approximately λ/NA), however sensitivity to tilt and cover slip thickness are dramatically increased (λ/(NA)³, and λ/(NA)⁴ respectively). While the combination of shorter laser wavelength and higher NA enables 25 gigabytes of storage with a standard 12 cm diameter disk, tilt and thickness sensitivity require the use of a thinner optical cover layer. Consequently, the trend in future optical memory products is toward thinner protective cover layers. For example, an optical cover slip thickness of less than 0.1 mm is being considered for next generation products such as the Blue-ray Disk.

The birefringence of an optical disk substrate and/or cover layer is related to the inherent anisotropy of the substrate material and to various local effects, distortions and stresses introduced during manufacture. As the thickness of the required optical cover slip/substrate is reduced it becomes increasingly difficult to uniformly flow injected material into the mold without introducing high internal stresses. These internal stresses result in unacceptable warp and birefringence. Because of high stresses associated with injecting molten polymer into a thin cavity, directly replicating microstructure onto thin substrates via injection molding is not practical.

For small diameter disks (i.e. 5-8 cm.), such as the ones used in Personal Digital Assistants (PDA's) and Digital Electronic Cameras, disturbances caused by center gating can influence the quality of the innermost tracks on the disk. These disturbances are associated with local turbulence, shear, and packing variation near the center gate in the mold and can produce locally poor flatness and high birefringence. As the minimum track diameter is reduced, these problems may be exemplified.

For these, and other, reasons various hot embossing approaches have been considered for the formation of optical memory microstructure on thin polymeric sheets and/or web. Many of these methods were proposed to increase the manufacturing rate for current optical memory products such as CD and DVD, and were designed around the concept of forming a microstructure pattern on a continuous web of material by passing the web between a roller and a stamper.

To date, there have been two types of continuous web processes proposed. These processes include “in-line” and “off-line” methods. In-line continuous web processes integrate web extrusion with microstructure pattern formation in the same process, while off-line continuous web processes carry out web formation on pre-fabricated web material that is manufactured on another production line. The goal of in-line formation is to contact the web with a stamper immediately after web extrusion and while the web is still hot. Examples of in-line processes include those described in U.S. Pat. Nos. 5,137,661; 4,790,893; 5,433,897; 5,368,789; 5,281,371; 5,460,766; 5,147,592; and 5,075,060, the disclosures of which are herein incorporated by reference. The integration of web extrusion and web formation requires that a disk manufacturer not only engage in the business of producing optical disks but also in web extrusion. This makes the overall system a highly complex process, at a point in the process where it may not be desirable. Furthermore, because the disk manufacturer may not enjoy the same economies of scale that a plastic web manufacturer does, the cost per unit for disks formed with in-line processes may be higher than that for off-line processes.

One method of web formation, which may be used for in-line processes for optical memory production, is proposed by Kime, U.S. Pat. No. 6,007,888, entitled “Directed Energy Assisted In Vacuo Micro Embossing” which issued Dec. 28, 1999, the disclosure of which is herein incorporated by reference. Kime discloses a continuous manufacturing process using directed energy assisted micro embossing. The patent describes a directed energy source used to heat web material and a stamper before they are pressed together by a pair of nip rollers.

Although Kime is well regarded for what it teaches, when increasingly higher density data devices are formed, a number of factors not normally at issue arise. For example, the present inventors have found that unavoidable variation in web surface texture and web thickness exist and can interfere with fine microstructure reproduction. These variations result in locally, non-uniform contact pressure between the web and stamper. In a process where the web is softened to form the microstructures, simply increasing the average contact pressure fails to adequately solve this problem, as excessively high contact pressure may result in a distorted image of the surface due to elastic rebound within the web material after pressure is removed. Stamper/web relative movement can also cause ‘smearing’. Smearing distorts the shape of the data tracks and/or pits on a microscopic scale. These distortions can interfere with tracking and can also increase read-back jitter and error rates.

It has been found that commercially available web may have unacceptable thickness variation in the form of periodic ripple and gauge variation. Processes that do not reform the entire thickness of the web may leave residual thickness patterning that degrades disk performance. For example, patterned web variation of less than 0.1% of a standard DVD disk thickness has been observed to create unacceptable focus and tracking servo disturbances. Sensitivity to these variations is increased as the optical drive NA is increased. Accordingly, there is a need for a method and/or apparatus, which eliminates the negative effects produced by variations in web surface texture and web thickness.

Additionally, typical web extrusion processes result in birefringence that is strongly oriented in the extrusion direction. When disks are formed from such web, and rotated in an optical drive, the birefringence orientation rotates with the disk. If there are any imperfections in the optical system, rotating birefringence orientation will result in read back signal modulation at twice the rotational rate. It has been found that single pass in-plane birefringence must be reduced below 15 nm to substantially eliminate the effects of read back signal modulation caused by extrusion orientation. While specialized techniques have been developed to reduce in-plane birefringence of extruded polycarbonate web, present manufacturing variation makes achieving high yields at 15 nm single pass difficult, increasing the cost of the web. Accordingly, there is a need for a method and/or apparatus, which eliminates the negative effects produced by extrusion related birefringence orientation.

As web thickness is reduced below 0.25 mm, it becomes possible to form the web using solvent casting techniques. Solvent casting can significantly reduce ripple and in-plane birefringence. Unfortunately solvent casting is an expensive process that drives up the cost of optical memory disk manufacturing. Additionally, solvent casting has been seen to result in high levels of perpendicular birefringence. Values greater than 4500 nm/mm have been observed. While perpendicular birefringence was of little concern with standard Compact Audio Disks (CD's), it becomes more critical as the angle of the marginal rays impinging light increases, as is the case with 0.85 NA objective lenses proposed for next generation optical memory disks. Perpendicular birefringence can result in astigmatism that degrades the optical performance of the system. Accordingly, there is a need for a method and/or apparatus, which eliminates the negative effects of high perpendicular birefringence.

In a typical roll-to-roll embossing process, an image is replicated onto a moving web of substrate material. Because of the risk of generating mechanical disturbances during the actual replication process, and because of the distorted shape of a hole punched with a rotary punch, the required center hole is typically punched at a later time. Forming the center hole in a separate process step increases equipment cost, manufacturing complexity, and reduces achievable yield. Accordingly, there is a need for a method and/or apparatus, which allows the required center hole to be formed during the replication step.

Continuous roll-to-roll replication processes capable of correcting web surface texture and thickness defects become increasingly difficult to employ as web thickness is reduced below approximately 0.25 mm. Accordingly, there is a need for a method that produces thin films with replicated optical memory microstructure having pit-and-land patterns, groove-and-land patterns, or a combination of both patterns, produced using an essentially flat tool that at some point during the replication process simultaneously contacts and re-forms substantially all of the replicated area, forms a center hole, provides optimum cooling to minimize warp and birefringence, and that may also act as a heat sink and mechanical stabilizer during subsequent manufacturing steps.

### SUMMARY OF THE INVENTION

In response to the foregoing issues, the present invention provides a method and/or apparatus for the manufacturing of optical memory microstructure carrier films, optical memory substrates, and/or optical disks, which includes supplying a web of material to a substrate forming apparatus, forming a microstructure image, such as an information and/or tracking structure for an optical memory disk device, that utilizes a web of polymeric material in a melt-forming process. The melt-forming process may incorporate a substantially flat tool and/or stamper and reduce the effects of web surface defects and thickness variation, reduce birefringence artifacts resulting from the web manufacturing process, form a hole through the web during the replication process that is preferably properly shaped and centered within the optical memory disk image, provide optimum cooling conditions to minimize warp and replication process related birefringence, and that may also provide mechanical stability and heat sinking for the thin web during subsequent manufacturing steps. The embodiments disclosed herein may be used with thin polymeric material (thickness of 0.6 mm or less, preferably 0.25 mm or less).

A preferred embodiment of the present invention is a method of forming microstructures on the surface of a web of polymeric material comprising the steps of providing a web of polymeric material, continuously transporting the web into and out of a process accumulator zone, which encompasses a replication process zone containing mating platens. Each of the platens may further include an insert plate on which a stamper is formed or to which a stamper is attached. The insert plates may be designed to function as transportable carriers or to remain fixed within the mating platens, depending on the particular embodiment. The mating platens with stamper inserts are used to replicate a microstructure image of the stamper surface into the polymeric material while re-forming the polymeric web, and forming a centrally located hole through the web of polymeric material. The various embodiments disclose several methods for forming a hole through the web. Preferably, the stamper and/or web is independently heated from other components of the system, allowing a substantial percentage of the processed cross section of the polymeric web to be heated to at least the melt-flow temperature (T_{f}) of the polymeric web and subsequently cooled to at or near the glass transition temperature (T_{g}) of the polymeric web during the replication process. The method may further comprise the step of utilizing additives or surface treatments that temporarily or permanently lower the melt-flow temperature below that of unmodified polymer. Preferably, the time required for the melt-forming step is less than 10 seconds, more preferably 3 seconds or less.

A preferred embodiment of the present invention further discloses a method that includes stabilizing the web of polymeric material in the replication process zone during replication and re-forming. Stabilizing the web during the replication step may prevent microscopic distortion of the replicated structure and also may prevent larger area distortion to the optical memory information carrier. Methods of stabilizing may include the use of an accumulated loop of web between two sets of servo controlled isolation drives. A web accumulator zone would be established before and after the replication process zone, thereby allowing continuous web motion outside of the process zone, but permitting the web to be intermittently held motionless within the process zone during replication and re-forming. Additionally, the web may be pre-tensioned and/or pre-clamped within the process zone, for example by means of an inner tension control servo loop or an annular ring assembly included in the mating platen assemblies. A most preferred method of stabilizing the web of polymeric material in the replication process zone during replication and re-forming is stopping rotation of the payoff roll and take up roll, then beginning rotation after the replication and re-forming to flow a new section of the web into the replication zone.

While there are applications where a single layer of thin web with replicated microstructure would be useful, for example “floppy” optical disks, currently preferred embodiments concentrate on improved methods for manufacturing multi-layer structures, such as the proposed “Blue-ray Disk”.

One embodiment of the present invention is a method of melt-forming a microstructure image on the surface of polymeric material having a melt flow temperature (T_{f}) and a glass transition temperature (T_{g}). The embodiments disclosed are particularly useful for melt-forming microstructure images on a web of polymeric material having a thickness of 0.6 mm or less, preferably 0.25 mm or less. The process begins with providing a web of polymeric material and adapting the web of polymeric material to continually flow into a replication zone between a first platen and a second platen. At least one of the platens is equipped with an insert comprised of or carrying a microstructured surface, such as that provided by a stamper, for melt-forming the microform image. The stamper(s) surface should be substantially flat after the mating halves of the platen have been pressed together. Next, the method involves heating the web of polymeric material to at least the melt flow temperature (T_{f}) of the polymeric material and forming the microstructure image into the polymeric material with the stamper(s) to produce a melt formed microstructure image. Preferably, heating the web of polymeric material comprises heating a substantial portion of the cross section to at least the melt flow temperature (T_{f}), in this way the process may be utilized to reform the web, reducing web manufacturing imperfections such as thickness variation, ripple, and birefringence. Additionally, initial web thickness may be selected to be greater than the fully clamped cross-sectional thickness of the tooling, in this way the additional volume of polymer may be utilized to improve packing and compensate for shrinkage. The invention contemplates several methods of heating the polymeric material, including pre-heating the web to less than T_{f} before initial contact with the stamper(s), directly or indirectly heating the stamper(s) to or above T_{f} prior to contact with the polymeric material, directly or indirectly heating the stamper(s) to or above T_{f} after contact with the polymeric material, directly or indirectly heating the web to or above T_{f} before or during initial contact with the stamper(s), directly or indirectly heating the web to or above T_{f} after initial contact with the stamper(s). These and similar heating methods may be used singly or in any combination. After the completion of the melt-forming process, the reformed web may be separated from one or both platen insert/stamper surfaces when the interface temperature has fallen below T_{f}. The method may further comprise the step of introducing surface treatments and/or flow enhancers that lower the effective melt-flow temperature below that of unmodified polymer before and/or during the melt-flow process. The method may further comprise the step of introducing surface treatments and/or additives that increase T_{f} and/or T_{g} above that of the unmodified polymer as a result of exposure to the melt-flow process.

In an embodiment of the present invention, an insert is attached to a first platen and a transportable insert removably secured into a second platen. However, the positions of the platens may be reversed with the transportable insert removably secured to the first platen and the non-transportable insert attached to the second platen. The non-transportable insert may carry or be comprised of a microstructured surface, for example an image of an optical memory disk information layer such as that provided by a stamper. The other insert may carry or be comprised of an optical quality polished surface. Alternatively, both inserts may be comprised of or carry a microstructured surface such as that provided by a stamper. After the completion of the melt-forming process, the platens open and the re-formed web is transferred to and captured by the transportable insert. Next, the transportable insert may be removed from its platen assembly and is transferred into a first evacuable deposition chamber, in which at least one coating is deposited onto the exposed microstructured surface. During this deposition process, the transportable insert acts as a heat sink and mechanical stabilizer for the thin section of polymeric film. When the required deposition processes have been completed, the transportable insert exits the first evacuable deposition chamber. Next, the coated side of the melt formed replica is bonded to a carrier substrate to form a self supporting substrate assembly, and then the entire assembly is released from the transportable insert. Depending on the type of optical memory disk being manufactured the replication and assembly process may now be complete. For example, a single layer disk may be complete whereas a dual layer disk requires additional processing. With a dual layer disk, the bonded carrier/melt-formed polymeric film assembly would have a second layer of microstructure formed into the uncoated surface of the polymeric film. In this case the substrate assembly is transported into a second evacuable deposition chamber, wherein at least one semi-reflective coating is deposited onto the exposed surface of the polymeric film. The bonded carrier substrate acts as a heat sink and mechanical stabilizer for the thin polymer during this process. Finally, the fully coated optical memory disk assembly is bonded to an optical cover slip.

In another embodiment, an insert comprised of or carrying a microstructured surface such as that provided by a stamper is attached to a first platen, and a previously coated carrier substrate insert is removably secured into a second platen, wherein the melt-forming process simultaneously re-forms the polymeric web, replicates the pattern on the microstructured surface of the stamper insert, and laminates the thin polymeric web to the carrier substrate insert. The coated carrier insert of this embodiment may be an injection molded polymer carrier (for example, approximately 1.1 mm thick) having a track microstructure coated with a reflective metal layer, or a reflective metal layer, a second dielectric layer, an active recording layer, and a first dielectric layer. Additional layers may be incorporated depending on the characteristics of the desired media. After the melt-forming replication process is complete, the platens open and the laminated assembly is removed. Next, the laminated substrate assembly is transported into a second evacuable deposition chamber, wherein at least one semi-reflective coating is deposited onto the exposed surface of the polymeric film. The combined mass, thermal properties and rigidity of the laminated assembly stabilizes the thin section of film during the coating process. Finally, the fully coated optical memory disk assembly is bonded to an optical cover slip. While the maximum benefit of this embodiment may be realized in the production of dual layer optical memory disks, the described process is applicable to the production of a single layer optical memory disk. For example, an injection molded carrier substrate containing appropriate track microstructure and previously coated with at least one vacuum deposited layer may require the application of an optical cover slip. Forming this cover layer by melt-forming and laminating polymeric web to the injection-molded substrate may have a number of advantages over prior art. As previously noted a feature of the melt-forming process includes raising a substantial percentage of the web cross-section to its flow temperature (T_{f}), in this way the process may be utilized to reform the web, reducing web manufacturing imperfections such as scratches, thickness variation, ripple, and birefringence. Web reforming at the time of lamination will allow the use of lower cost cover film. Initial web thickness may be selected to be greater than the required final thickness of the optical cover layer, and that of the fully clamped cross-sectional thickness of the tooling, to improve packing, lamination uniformity, and compensate for shrinkage.

In an embodiment of the present invention, an insert designed to facilitate the release of the melt-formed replica is attached to a first platen and a replica-capturing insert is attached to a second platen. However, the positions of the platens may be reversed with the replica capturing insert attached to the first platen and the replicare-leasing insert attached to the second platen. The capturing insert may carry or be comprised of a microstructured surface, for example an image of an optical memory disk information layer such as that provided by a stamper. The replica-releasing insert may carry or be comprised of an optical quality polished surface. Alternatively, both inserts may be comprised of or carry a microstructured surface such as that provided by a stamper. After the melt-forming process is completed the melt-formed polymeric web is released from the non-capturing insert and is retained by the capturing insert as the platens open. Next, the exposed melt formed polymer surface is contacted with and captured by a carrier plate extraction tool. The actions of the carrier plate extraction tool and capturing insert are coordinated to facilitate the transfer of the melt-formed film to the extraction tool. After this transfer, the melt-formed film is completely free from the opposing platens and inserts. The invention discloses several methods for extracting the melt formed polymer film that protect the melt formed image from contamination and abrasion, such as the addition of novel compliant layers between the melt formed image and the extraction tool. After extraction, the carrier plate and melt-formed polymer film is transported into a first evacuable deposition chamber, wherein at least one coating is deposited onto the melt formed polymer to produce a coated melt formed polymer surface. The carrier plate is designed to provide uniform contact over the entire microstructure pattern area of the replica. In this way the carrier plate acts as a heat sink and mechanical stabilizer for the thin polymer during the deposition process. Next, the coated melt-formed polymer film is bonded to a carrier substrate to form a stabilized substrate assembly, and the coated melt-formed polymer is released from the carrier plate. Depending on the type of optical memory disk being manufactured the replication and assembly process may now be complete. For example, a single layer disk may be complete whereas a dual layer disk requires additional processing. With a dual layer disk, the bonded carrier/melt-formed polymer film assembly would have a second layer of microstructure formed into the uncoated surface of the polymeric film. In this case the substrate assembly is transported into a second evacuable deposition chamber, wherein at least one semi-reflective coating is deposited onto the exposed surface of the polymeric film. The bonded carrier substrate acts as a heat sink and mechanical stabilizer for the thin polymer during this process. Finally, the twice coated melt formed polymer film is bonded to an optical cover slip.

One embodiment of the present invention provides a process for melt-forming a thin film of polymeric web with a thickness of 0.6 mm or less, preferably 0.25 mm or less, wherein a replication step is performed with a flat stamper and the melt-formed area of the web is heated to at least T_{f} during a continuous or semi-continuous process.

Another embodiment of the present invention provides a method and apparatus to punch a hole in a web of polymeric material during a melt-forming replication step, wherein the replication step is performed with a flat stamper and the embossed area of the web is heated to at least T_{f} during a continuous or semi-continuous process.

Another embodiment of the present invention provides a process for melt-forming a thin film (thickness of 0.6 mm or less, preferably 0.25 mm or less) that simultaneously replicates information and/or track structure for an optical memory disk on one surface of the web, reduces web ripple and gauge variation in the melt-formed area of the web, and accurately punches a centered hole in the melt-formed image of the stamper surface.

Another embodiment of the present invention provides a process for melt-forming a thin film (thickness of 0.6 mm or less, preferably 0.25 mm or less) that simultaneously replicates information and/or track structure for an optical memory disk on both surfaces of the web, reduces web ripple and gauge variation in the melt-formed area of the web, and accurately punches a centered hole in the melt-formed image of the stamper surface.

Another embodiment of the present invention provides a process for melt-forming a thin film (thickness of 0.6 mm or less, preferably 0.25 mm or less) that simultaneously replicates information and/or track structure for an optical memory disk on one surface of the web, reduces the perpendicular birefringence of the melt-formed area of the web and accurately punches a centered hole in the melt-formed image of the stamper surface.

Another embodiment of the present invention provides a process for melt-forming a thin film (thickness of 0.6 mm or less, preferably 0.25 mm or less) that simultaneously replicates information and/or track structure for an optical memory disk on both sides of the web, reduces the perpendicular birefringence of the melt-formed area of the web and accurately punches a centered hole in the melt-formed image of the stamper surface.

Another embodiment of the present invention provides a process for melt-forming a thin film (thickness of 0.6 mm or less, preferably 0.25 mm or less) that simultaneously replicates information and/or track structure for an optical memory disk on one surface of the web, reduces in-plane birefringence in the melt-formed area of the web, and accurately punches a centered hole in the melt-formed image of the stamper surface.

Another embodiment of the present invention provides a process for melt-forming thin film (thickness of 0.6 mm or less, preferably 0.25 mm or less) that simultaneously replicates information and/or track structure for an optical memory disk on both surfaces of the web, reduces in-plane birefringence in the melt-formed area of the web, and accurately punches a centered hole in the melt-formed image of the stamper surface.

Another embodiment of the present invention provides a melt-forming process that stabilizes a web of polymeric material during the replication process to result in a higher quality replication.

Another embodiment of the present invention provides a melt-forming process that limits and preferably eliminates movement between the stamper and the polymeric web during the melt-forming replication process.

Another embodiment of the present invention provides a method of manufacturing optical memory disks comprising injection molding a thick (˜1.1 mm) plastic carrier substrate with information and/or tracking microstructure, applying a vacuum coated reflective layer, or reverse order vacuum coated reflective/dielectric/active recording/dielectric layers, onto the injection molded microstructure, utilizing the coated carrier substrate as an insert in tooling designed to simultaneously melt-form a second layer of optical memory microstructure onto thin polymeric web (thickness of 0.6 mm or less, preferably 0.25 mm) while bonding the non-microformed surface of the web to the coated surface of the injection molded carrier substrate, forming a two layer optical memory disk structure.

Another embodiment of the present invention provides a method of manufacturing optical memory disks comprising injection molding a thick (˜1.1 mm) plastic carrier substrate without information and/or tracking microstructure, melt-forming an information and/or tracking microstructure onto one side of a thin polymeric web (thickness of 0.6 mm or less, preferably <0.25 mm), vacuum depositing required dielectric/active recording/dielectric/reflective layers, or reflective layer in the normal order, and bonding the vacuum coated surface of the melt-formed web to the carrier substrate, eliminating the necessity of optical read-back through a bond-line, resulting in a lower read-back error rate.

Another embodiment of the present invention provides a method of manufacturing optical memory disks comprising injection molding a thick (˜1.1 mm) plastic carrier substrate without information and/or tracking microstructure, melt-forming an information and/or tracking microstructure onto both sides of a thin polymeric web (thickness of 0.6 mm or less, preferably <0.25 mm), vacuum depositing required dielectric/active recording/dielectric/reflective layers, or reflective layer in the normal order on one side of the web, bonding the vacuum coated surface of the melt-formed web to the carrier substrate, subsequently vacuum depositing the required semi-reflective, or semi-reflective/dielectric/active recording/dielectric layers in the reverse order on the second surface of the melt-formed web, and then bonding the coated second layer to an optical cover layer. Another embodiment of the present invention provides a method of manufacturing optical memory disks comprising injection molding a thick (˜1.1 mm) plastic carrier substrate with information and/or tracking microstructure, applying a vacuum coated reflective layer, or reverse order vacuum coated reflective/dielectric/active recording/dielectric layers, onto the injection molded microstructure, utilizing this coated replica as an insert in tooling wherein thin polymeric web may be simultaneously melt-formed without the formation of additional microstructure and laminated to the coated surface of the carrier replica.

Another embodiment of the present invention provides a process for melt-forming a thin film (thickness of 0.6 mm or less, preferably 0.25 mm or less) that simultaneously replicates information and/or track structure for an optical memory disk on both surfaces of the web, reduces web ripple and gauge variation in the melt-formed area of the web, and accurately punches a centered hole in the melt-formed image of the stamper surface.

Another embodiment of the present invention provides for melt-forming polymeric web with a stamper utilizing a process and apparatus that replicates a high quality diffraction structure, which reduces web ripple and gauge variation.

Another embodiment of the present invention provides for melt-forming polymeric web with a stamper utilizing a process and apparatus that replicates a high quality diffraction structure, which reduces perpendicular birefringence by 25% to 80%.

Another embodiment of the present invention provides for melt-forming polymeric web with a stamper utilizing a process and apparatus that replicates a high quality diffraction structure, which reduces in-plane birefringence.

Another embodiment of the present invention provides for melt-forming polymeric web with a stamper utilizing a process and apparatus that replicates a high quality diffraction structure, which includes replicating in a vacuum.

Another embodiment of the present invention provides for melt-forming polymeric web with a stamper utilizing a process and apparatus that replicates a high quality diffraction structure, which includes punching a central hole in a replica simultaneously with the melt-forming replication process, which eliminates the time and expense required to punch a hole in a separate step.

Another embodiment of the present invention provides a process for melt-forming a thin film of polymeric web (thickness of 0.6 mm or less, preferably 0.25 mm or less) that simultaneously replicates an optically polished surface and laminates the melt-formed film to an information carrier substrate, reduces web ripple and gauge variation in the melt-formed area of the web, and accurately punches a centered hole in the melt-formed image of the stamper surface.

Another embodiment of the present invention provides for melt-forming polymeric web with a stamper utilizing a process and apparatus that replicates a high quality optical finish, which reduces web ripple and gauge variation.

Another embodiment of the present invention provides for melt-forming polymeric web with a stamper utilizing a process and apparatus that replicates a high quality optical finish, which reduces perpendicular birefringence by 25% to 80%.

Another embodiment of the present invention provides for melt-forming polymeric web with a stamper utilizing a process and apparatus that replicates a high quality optical finish, which reduces in-plane birefringence.

Another embodiment of the present invention provides for melt-forming polymeric web with a stamper utilizing a process and apparatus that replicates a high quality optical finish, which includes replicating in a vacuum.

Another embodiment of the present invention provides for melt-forming polymeric web with a stamper utilizing a process and apparatus that replicates a high quality optical finish, which includes punching a central hole in a replica simultaneously with the melt-forming replication process, which eliminates the time and expense required to punch a hole in a separate step.

### BRIEF DESCRIPTION OF THE DRAWINGS

In order to assist in the understanding of the various aspects of the present invention and various embodiments thereof, reference is now be made to the appended drawings, in which like reference numerals refer to like elements. The drawings are exemplary only, and should not be construed as limiting the invention.

FIG. 1 is a perspective view of an apparatus for forming web material for use in optical memory in accordance with the present invention, which illustrates a stamper equipped platen assembly having a punch nip;

FIG. 2 is a perspective view of another apparatus for forming web material in accordance with the present invention, which illustrates a platen stamper equipped with a puncher;

FIG. 3 is a perspective view of another apparatus for forming web material in accordance with the present invention, which illustrates an alignment plate equipped with a puncher;

FIG. 4a is a perspective view of another apparatus for forming web material in accordance with the present invention, which illustrates a pay off piston in a retracted position and a take up piston in an extended position;

FIG. 4b is a perspective view of another apparatus for forming web material in accordance with the present invention, which illustrates a pay off piston in a mid extended position and a take up piston in a mid extended position;

FIG. 4c is a perspective view of another apparatus for forming web material in accordance with the present invention, which illustrates a pay off piston in an extended position and a take up piston in a retracted position;

FIG. 5 is a graphical representation that illustrates the reduction in perpendicular birefringence after a polycarbonate material is heated to the melt flow (T_{f}) temperature of the polycarbonate.

FIG. 6A is a perspective view of a platen stamper in accordance with the present invention;

FIG. 6B is a view of the replication zone with a platen stamper in accordance with the present invention;

FIG. 6C is a perspective view of a platen stamper having a domed shape in accordance with the present invention; and

FIG. 7 is a perspective view of a web surface after embossing in accordance with an embodiment of the present invention that details the level bridges between the pits and grooves embossed into a web.

### DETAILED DESCRIPTION OF THE INVENTION

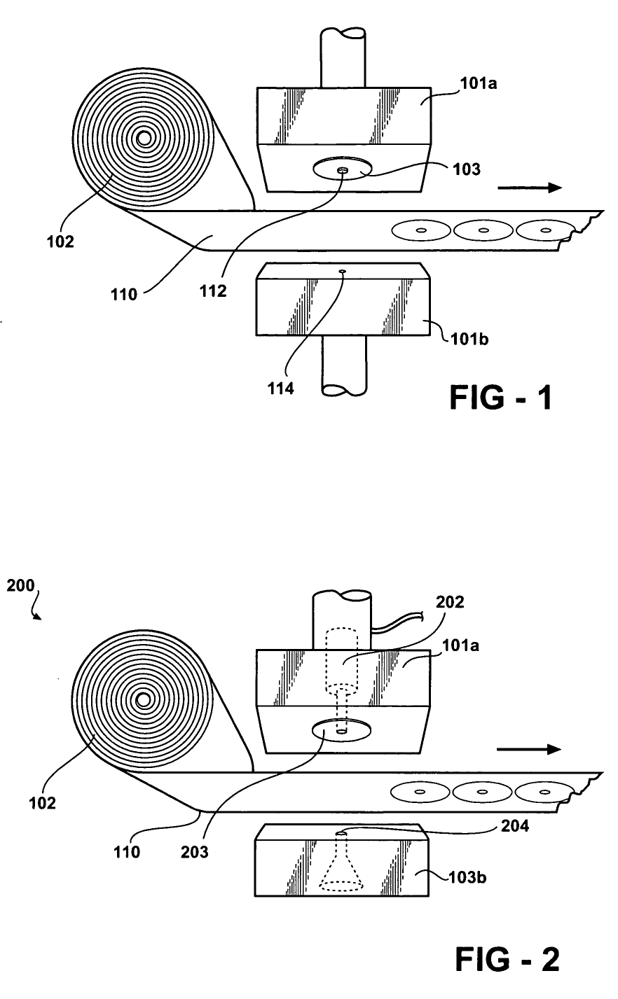

Referring now to FIG. 1, depicted therein is a device, generally referred to as 100, for forming optical memory in accordance with the present invention. The device 100 includes a web payoff device 102, or simply a web payoff, a web path in which web material 110 travels, and a web forming apparatus disposed in the web path. The web forming apparatus includes a temperature controlled mating platen assembly that may be supported by a hydraulic, pneumatic, electrical, or mechanically controlled pressing device 106a and 106b. Each half of the mating platen assembly 101a and 101b may be fabricated with provisions for accepting a carrier insert comprised of or carrying a microstructured surface such as that provided by a stamper 103.

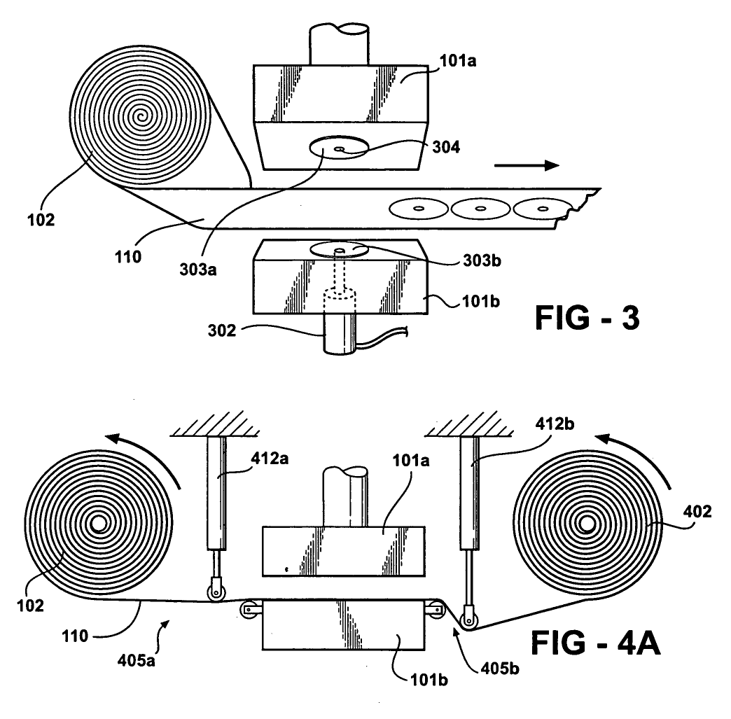

The stamper is any tool suitable for melt-forming a desired surface finish and/or impression in web material or an optical memory substrate. Either or both of the platens 101a and 101b may be equipped with a stamper, as illustrate in FIG. 1 as 103, FIG. 2 as 203 and FIG. 3 as 303a and 303b. The stamper is preferably a disk shaped embossing tool, although in alternative embodiments the stamper could have any shape, such as rectangular, oval, triangular, oblate, irregular, etc. Stampers may be optically polished or may have fine features for replicating microstructures, such as the grooves and/or pits typically employed in optical memory disks. The fine features may range from greater than several microns to 0.01 microns or less in width, length and depth.

The carrier inserts are designed to facilitate rapid heating and cooling, such that a controlled time-at-temperature profile may be generated within the polymeric web and at the interface of the stamper(s) and the polymeric web. Controlled rapid heating may be provided by any suitable means. One preferred heating method utilize the stamper(s) as a plate(s) in a “lossy” capacitor, where a carefully selected insulating material converts an externally applied high frequency field into heat. In a preferred embodiment, the lossy dielectric may include the polymeric web material. Another method heats the stamper(s) via direct ohmic heating. Another method bonds the stamper(s) to an ohmic heating element. Another heating method imbeds induction-heating coils within the platens or within the stamper carrier inserts. The web may be illuminated before the stamper closes. Yet another method utilizes carrier inserts that are substantially transparent to electromagnetic energy that may be absorbed by the stamper(s) and/or polymeric web. In this case at least one stamper may also be transparent to a portion of the radiated electromagnetic spectrum. For example, a semi-transparent stamper may absorb infrared radiation and pass ultraviolet radiation that is then absorbed in the polymeric web, generating heat that is localized in the semi-transparent stamper and polymeric web. The radiation source may be imbedded within the temperature controlled base platen assembly(s), the stamper carrier insert(s), or may be provided by an external source. In these ways, process heat may be rapidly added before and/or after stamper(s) contact with the polymeric web. Another preferred method inductively heats the stamper(s) with an external coil that is removed as the platens close. Alternatively, a directed energy source, such as a high power laser, may be used to heat the stamper(s) and/or web immediately prior to and/or after closing the platens. Heating methods may be used alone or in any combination to achieve the desired heating rates while allowing controlled cooling, primarily by conduction into the cooler base platens.

The platens are designed to press together with precise alignment accuracy. The mating stamper carrier inserts form a cavity between the opposing surfaces of the platens. When producing an optical memory device, the gap between the opposing surfaces establishes the final desired polymeric film thickness and/or spacing between optical memory disk layers. For example, the spacing between opposing stamper carrier insert surfaces may be 30 to 100 microns. The platens may further include center inserts that serve as alignment and capturing aids for the stamper carrier inserts. Additionally, the opposing stamper carrier inserts may include, or include provisions for, a sub-assembly designed to form a closed cylindrical bridge between the two mating carriers. The cylindrical bridge sub-assemblies may be designed to function as opposing components of a punching unit. The punching action is preferably set to occur as the mating carriers are pressed together or may be initiated by an external device timed to extend the cylindrical bridge at an appropriate time during the melt-forming process. As a result, a precisely located hole can be formed. In addition to forming a hole, the carrier assemblies may be designed to cut the replica completely free from the web of polymeric material. However, the cutting step should be designed to avoid tearing or pulling the web, which causes image smearing, short range distortion to the track structure, and longer range distortion to the shape of the disk.

The present invention discloses several methods for creating a hole in the polymeric material 110. A stamper 103 may be designed with a punch nip 112, as illustrated in FIG. 1. As the web material 110 is pressed between the platens 101a and 101b, the punch nip 112 creates a hole in the material 110. A nip receiver 114 may be set in the opposing platen 101b. Illustrating another preferred embodiment in FIG. 2, an independently actuated punch 202 may be situated in either platen 101a and 101b and centered within the optical memory disk information/track structure. In applications where a centered hole is not desired, the location of the punching assembly would be appropriate for the application. The timing of the hole forming operation is adjusted to result in a properly formed hole with no burrs and to reduce debris generation that may result from the punching operation. Because the melt-forming process re-forms the polymeric film, by raising a substantial percentage of its cross section to or above T_{f}, the hole forming process must allow the punch 202 to remain extended until the polymer cools below T_{f}. An alternative approach is to delay punching the hole until the web polymer cools below T_{f}, preferably below T_{g}. In this case, the hole forming process should not result in relative movement between the polymeric web 110 and the stamper(s) after microstructure formation. The material removed by the punching operation may be pushed through a hole 204 in the mating stamper insert assembly and ejected from the tooling, alternatively it may be captured by the punch 202 and ejected when the platens 101a and 101b open.

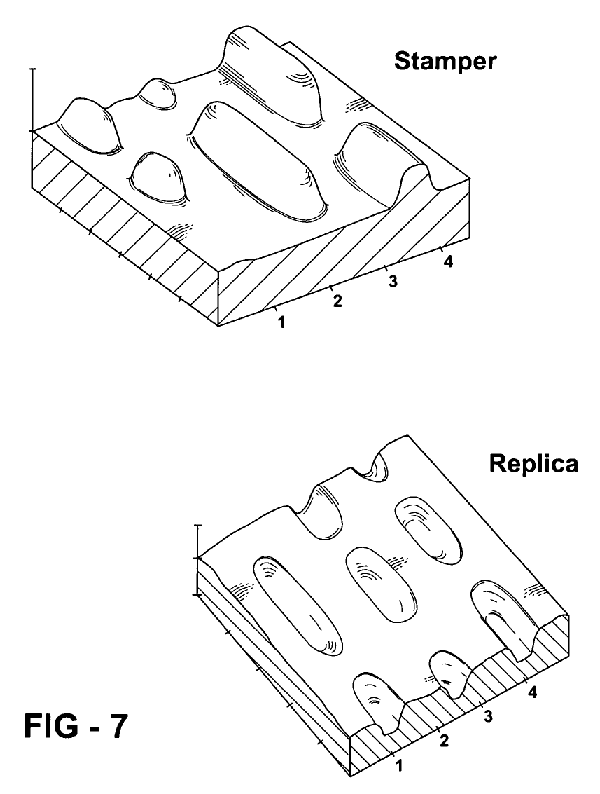

The preferred stamper/web contact time is a time sufficient to cause a substantial cross section of the web to achieve a temperature of T_{f}, and then cool to a temperature below T_{f} to allow the web to maintain its desired shape and microstructure upon separation from the stamper(s). One preferred configuration may allow the web to be heated above T_{f} in less than 0.5 seconds, and cool to near T_{g} in 6 seconds or less. Alternative configurations may allow the web to be heated above T_{f} in less than 0.5 seconds, and to cool near T_{g} in 3 seconds or less. Variables include heating method, stamper heat capacity and thermal conductivity, as well as the thermal properties of adjoining layers, including the polymeric web. Minimum contact time should be sufficient to allow the web to conform to the microform image and ensure a level surface in the areas that bridge the pits and grooves, lands and grooves or both created by the stamper, as illustrated in FIG. 7. Preferably, contact time should be sufficient to allow a substantial cross section of the polymeric web to reach T_{f}, thereby allowing the web to be re-formed. Preferably, the time of stamper contact with the web is about 10.0 seconds or less. Most preferably, the contact time is about 3 seconds or less.

The stamper is preferably formed of a rigid material that can be heated to a peak process temperature while maintaining the ability to both form a microstructure on the surface of the web and to easily transfer energy to the interface between the stamper and web of polymeric material upon contact. Representative stamper materials include, nickel, chrome, cobalt, copper, iron, zinc, etc., and various alloys of these metals. Additionally materials selected for specific electromagnetic radiation absorption and/or transmission characteristics may be used. The stamper may be composed of a single monolithic material, or of multiple layers of the same material or of different materials. A typical monolithic stamper is comprised of a 0.1 to 1.0 mm thick plate of material, and is more preferably comprised of an approximately 0.3 mm+/−0.1 mm thick plate of material. However, the stamper may also be comprised of multiple layers of different materials, designed to optimize the thermal response of the melt-forming replication system.

In one embodiment, the stamper(s) may be formed from materials selected to partially or completely absorb specific wavelength bands, including for example low frequency, high frequency, very high frequency, ultra high frequency, microwave, infrared, visible, and/or ultraviolet radiation. Representative structures may include relatively thin absorbing layer(s) formed over a transmitting backing substrate and/or carrier insert. Multiple layers may be employed to optimize heating phase energy absorption and cooling phase heat transfer to the backing material, in this way the melt-forming time vs. temperature curve may be optimized. The backing substrate and/or carrier insert material may be maintained at a relatively low temperature, for example near T_{g}. In this way a rapid responding, low heat capacity structure(s) may be formed that allows controlled heating and controlled cooling of the stamper/web interface. A similar structure may be formed on the surface of the opposing stamper carrier insert to absorb radiation passed by the first stamper and web, increasing absorption efficiency and heating uniformity. Additionally, both stamper carrier insert assemblies may be used to directly input energy to the system and to provide controlled cooling. At the end of the heating cycle, the combination of stamper thermal conductivity, backing substrate thermal conductivity, and backing substrate temperature allows the web material to be cooled at an optimum rate to minimize stress and birefringence, while still achieving a replication cycle time of less that 10 seconds, more preferably less than 3 seconds. Appropriate backing materials depend on the frequency of the electromagnetic energy. Selected metal alloys and ceramics may be appropriate for lower frequency operation. Silicon, glass, glass-ceramic, and quartz may be appropriate for higher frequencies, including microwave, infrared, visible and ultraviolet. By utilizing stamper carrier inserts that are transparent to selected wavelengths of energy it becomes possible to independently heat one or both stampers, an interface layer(s) between the backing carrier and stamper(s), and/or treated surfaces on the backing carrier and/or stamper(s). Additionally, by utilizing microstructure carrying surfaces and/or stampers that are transparent or partially transparent to select wavelengths of radiation it becomes possible to independently heat the opposing stamper, the polymeric web, and/or interface layers and/or coatings formed at the stamper polymeric web interface. As shown in FIG. 1, the stamper 103 is preferably substantially flat with the exception of the microform image for embossing the web 110. FIG. 3 illustrates an embodiment in which both platens 101a and 101b are equipped with a stamper 303a and 303b having a microform image for embossing the web 110.

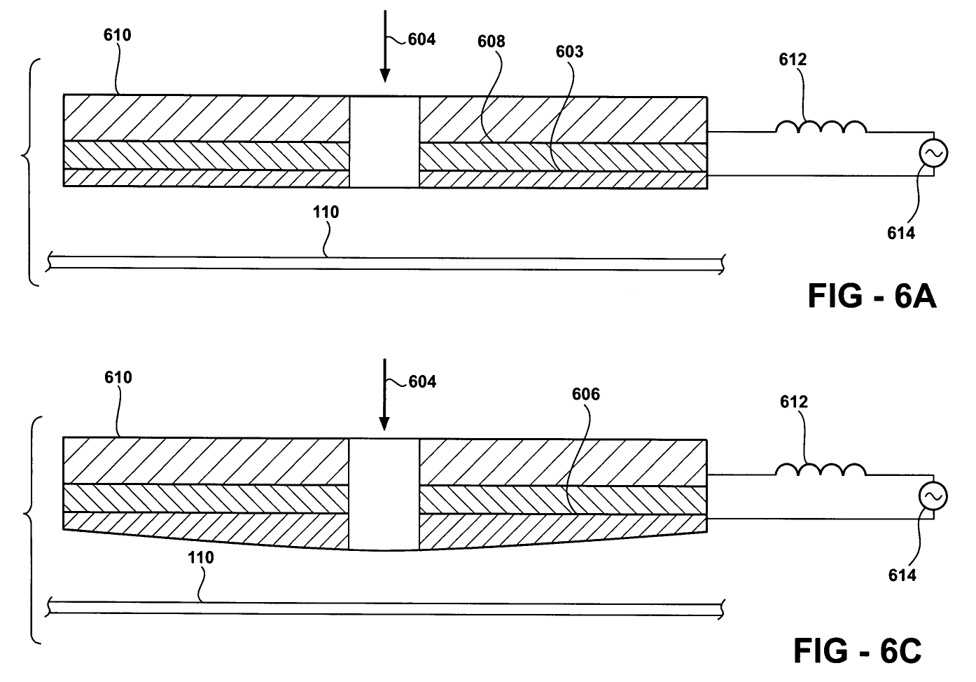

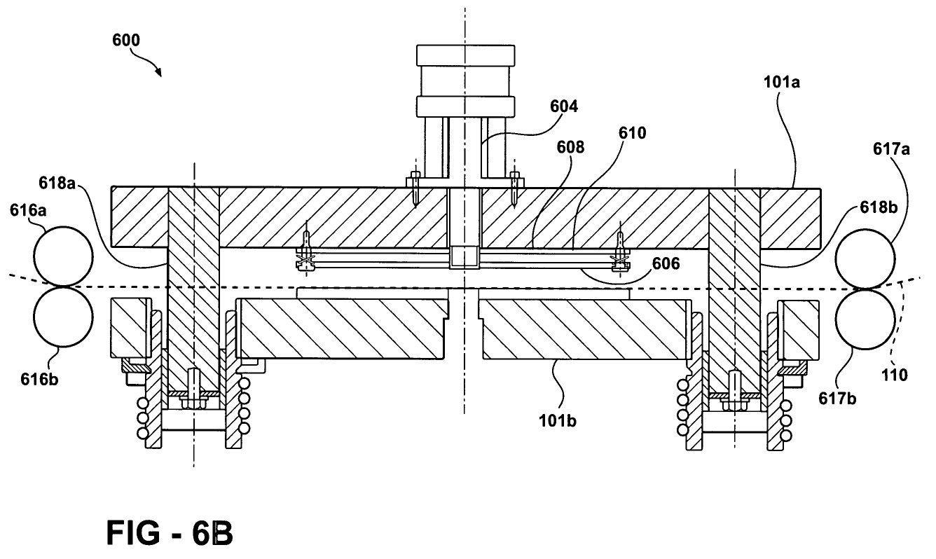

Referring to FIG. 6C, the stamper 606 may have a domed shape. In the domed stamper embodiment, as the platens 101a and 101b press closer together, the web 110 first contacts the opposing carrier substrate and stamper 606 near the center of the assembly. This is a result of the slightly domed shape of the carrier substrate and/or stamper 606. As the platens 101a and 101b press even closer together, the mechanism used to impart the domed shape to the carrier substrate and/or stamper is counteracted or overcome, allowing the domed surface(s) to be pushed down against a reference surface or stop. Consequently, the domed shape is progressively reduced as the platens close. Contacting at the center first, and progressively contacting at greater radii as the platens close, prevents the entrapment of air between the web and opposing surfaces. The domed shape may be provided by the direct action of a fixturing mechanism, or as a result of intentional stress and/or temperature imbalance within the carrier substrate and/or stamper. Additionally or alternatively, gas entrapment may be reduced by partially evacuating the space between the platens.

With reference to FIGS. 6A and 6B, the replication zone may contain mating platens 101a and 101b, a center hole punching assembly 604, and stamper carrier inserts comprised of the stamper(s) 603 backed by a thermally and electrically insulating layer 608, and a thermally conductive base material 610. Referring to FIG. 6A, the stamper may be heated using inductive heating. In this implementation the induction-heating coil/antenna 612 may further be imbedded in an electrically insulating material and surrounded by a material with optimized magnetic properties. When the induction heating power supply 614 is activated the stamper 603 is directly heated via induced currents within the stamper. Referring to FIG. 6B, in a preferred embodiment, two sets of rollers 616a, 616b, 617a and 617b guide the web of polymeric material 110 into the replication zone. The upper platen 101a provides support for the stamper carrier insert, which is comprised of a stamper 603, thermally and electrically insulating layer 608, and a thermally conductive base material 610 that may also contain an induction-heating coil/antenna. Alternatively, the induction heating coil/antenna may be mounted external to the tooling. In this implementation the induction heating coil/antenna would move aside before the tooling closed to begin the melt-forming process. As the polymeric material is set between the mating platens 101a and 101b, the center hole punch 604 may be positioned to extend through the various elements of the upper platen 101a to punch a hole through the polymeric material 110.

Both platens 101a and 101b may be equipped with a tool suitable for leaving an impression 303a and 303b in the web material 110 or optical memory substrate, as illustrated in FIG. 3. In this embodiment, a hole forming mechanism 302 may be situated in either platen 101a and 101b and centered within a circular image 303b, such as the microstructure image used for melt-forming a layer of information/track structure on an optical memory disk. Additionally, FIG. 3 illustrates an embodiment that provides a mechanism in which both sides of the web 110 are melt formed with a microformed image 303a and 303b simultaneously. During melt-forming, the web material is preferably stabilized in the replication zone (i.e. the area between the platens 101a and 101b) to minimize distortions in the microformed image that may result from differential movement between the stamper(s) 303a and 303b and polymeric web 110, and/or from tension and stretching forces acting on the web 110.

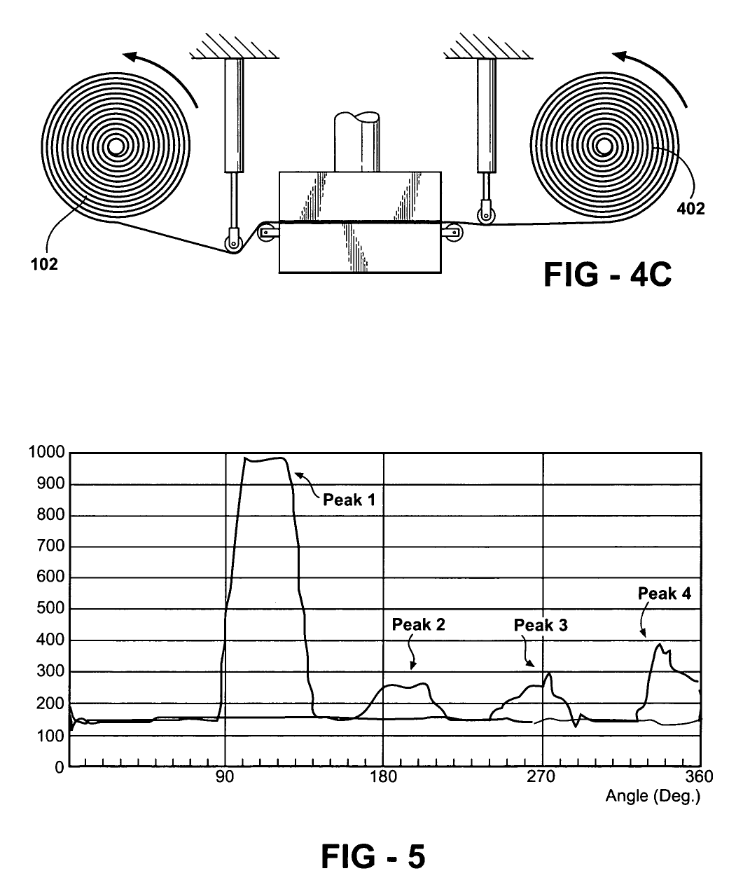

To stabilize the web 110 in the replication zone, one embodiment incorporates a web accumulator zone upstream 405a and downstream 405b from the replication zone, as illustrated in FIGS. 4A through 4C. The web accumulator zones 405a and 405b may include means for increasing slack and/or reducing web tension 407a and 407b immediately before the platens 101a and 101b close to after the platens 101a and 101b open. Stabilizing is intended to describe the condition of the web as the melt-forming process is conducted, such that the web is held to limited or no motion in the replication zone during the melt-forming.

In a preferred embodiment, the replication zone is further adapted to hold the web of polymeric material in a stable position during the melt-forming step. This may be accomplished by means of an annular clamp located near the periphery of the platen assembly. The clamp is designed to provide uniform and optimum web tension prior to, during, and after the melt-forming process. It is preferable to minimize tension immediately after the platens open as this may stretch the web and distort the shape of the replica.

The following embodiments of the present invention are described and illustrated as they relate to a method for forming an optical memory device. However, it should be appreciated that the following embodiments may be incorporated into any method that melt forms at least one microform image into the polymeric film. Additionally, the following embodiments disclose a method that simultaneously creates a hole in the polymeric film as the melt-forming is conducted.

One embodiment of the present invention begins with injection molding a 1.1 mm carrier. The carrier may include track microstructure on one surface and a center hole formed during the injection molding process. After injection molding the carrier, the disclosed embodiment further includes depositing the various vacuum coated layers onto the carrier, then melt-forming a second track microstructure and transparent spacer layer over the coated layers. Because the carrier is relatively thick, (1.1 mm) it can be readily formed using an injection molding process. However, in this case the injection-molded substrate does not serve as an optical cover layer, as it does in the similar thickness (1.2 mm) Compact Audio Disk, but as a mechanically stable carrier for a thinner optical structure. Because of this, the various vacuum coated layers that comprise a re-writable optical disk structure would be coated in reverse order, for example the reflective metal layer is applied directly over the injection-molded microstructure. The reflective metal layer would typically be followed by a dielectric layer, an active recording layer, and a second dielectric layer, as described more thoroughly in U.S. patent application Ser. No. 10/185,246, filed on Jun. 26, 2002, which is hereby incorporated herein by reference.

The carrier substrate with the first optical memory layer may require surface preparation before receiving the transparent spacer layer and second layer of optical memory microstructure. The preparation may include the application of a molecularly thin layer of refractive index matching material, surface active agent, adhesion promoter, heat activated adhesive, etc., on the coated surface of the carrier substrate. Next, the prepared carrier substrate is transferred to the melt-forming replication process zone. The replication process zone is comprised of opposing platen assemblies 101a and 101b, as illustrated in FIGS. 6a and 6b. One assembly may include an insert plate on which a stamper is formed or to which a stamper is attached. The second platen assembly is designed to accept the injection molded carrier disk as an insert. The injection molded carrier substrate is inserted into the receiving platen, with the coated microstructure side facing the opposing stamper. The injection molded carrier substrate is locked in place over a center locating assembly that may subsequently elastically deform the disk into a slightly domed shape (center area of the carrier substrate closer to the opposing platen).

Concurrently with the transferring of the coated carrier substrate into the receiving platen, a section of web is pulled into position between the opposing platens. The web is preferably less than 250 um thick, for example the web may be 30 um thick. The web is positioned between the coated microstructure side of the injection molded carrier substrate and the opposing stamper, such that the web is parallel to and centered over the microstructured surface area of both the stamper and carrier substrate. During this period of time the stamper may be subjected to an independent heating process that raises its temperature to, or above, the web polymer melt-flow temperature (T_{f}). A rapid response heating system may be used to optimize the thermal cycle. The stamper may be independently heated by any method including induction heating, direct ohmic heating, dielectric heating, radiative energy, directed energy, by conduction from an adjacent heating layer, or any combination of these or similar methods. The heating energy may be applied to, or from either side of, the stamper. Additionally, the stamper may be formed in layers with differing mechanical, electrical and thermal properties, etc., in order to achieve the dual objective of rapid independent heating and controlled cooling within a process cycle time of 10 seconds or less, more preferably 3 seconds or less.

After the stamper has reached an appropriate pre-clamping temperature, the platen assembly begins to close. The opening and closing action of the platens may be guided by multiple die posts. Two guideposts 618a and 618b are illustrated in FIG. 6B. However, other methods of operation may be used to align and guide the opposing platens. The stamper may or may not continue to be heated during this phase of the process. It is preferable that enough thermal energy is available to melt-flow a substantial percentage of the web cross section, most preferably the entire cross section, while still allowing the web to cool to near T_{g} within a total process time of 10 seconds or less, more preferably 3 seconds or less. As the platens close the web is rapidly heated to its melt-flow temperature (T_{f}), allowing low viscosity polymer to flow and progressively re-form in the space between the opposing platens. Because the polymer is pre-positioned over the entire surface, significant flow distances are not involved. A rapid, low stress, local redistribution of polymer is used to re-form the web, reducing the effects of web ripple, gauge variation, surface texture, in-plane birefringence, in-plane birefringence orientation, and perpendicular birefringence.

When the heating phase of the process is completed, the stamper begins to cool via conduction into its backing platen, which is kept at a constant temperature. The hot web is cooled by conduction into the cooling stamper and by conduction into the injection molded carrier substrate. The presence of the vacuum deposited coating stack on the injection molded carrier substrate protects it from transient thermal damage. The melt-flowed polymer forms a void free laminate with the prepared surface of the carrier substrate, and separates from the surface of the stamper as it cools to near T_{g}. Controlled separation from the stamper may be improved by the use of ejector pins and/or by injecting air between the stamper and web at an appropriate time in the process after the melt formed web has cooled sufficiently to maintain the form from the microform image on the stamper. The opposing platen assembly is designed to punch a center hole in the web, registered to the molded-in center hole in the carrier substrate.

In another embodiment, the platen may also cut the entire bonded assembly free from the web, in which case subsequent roll-roll processing would not be possible. After the platen assembly separates, the bonded carrier substrate with melt formed web structure is removed from the assembly. Removal may be assisted by the use of air jets, ejector pins, etc. The bonded disk assembly is then passed to a thin film vacuum coating unit. The combined thickness of the bonded assembly stabilizes its shape and protects it from thermal distortion during subsequent vacuum deposition processes. The fully coated 2-layer disk is passed to a bonding unit where the required optical cover layer is applied.

In another preferred embodiment, each of the opposing platens may be equipped with a stamper. In this embodiment, a second stamper insert replaces the injection molded substrate carrier. The second stamper may also contain a layer of optical memory disk microstructure. In this way two stampers may be used to simultaneously form replicated microstructure on both sides of an optical spacer layer (web) in one process step. Additionally, the second stamper may simply provide an optically polished surface not containing microstructure patterning. This embodiment may be designed to facilitate continued roll-to-roll processing after the melt-forming step, or may incorporate tooling that would cut the melt-formed replica from the supply web. Additionally, by selecting a web polymer with high dielectric loss it is possible to directly heat the web by the application of an oscillating voltage across the polymer. For example, metallic stampers could serve as opposing plates in a capacitor in which the web functions as an intentionally lossy dielectric. Directly heating the web polymer would allow the greatest control over heating and cooling profiles, because peak web temperature and cooling rate could be independently controlled.

In another preferred embodiment, one of the insert plates is transportable. Further, the transportable insert plate is designed to capture the polymeric web material at the completion of the replication step in the replication zone. In this embodiment the tooling may be additionally designed to cut the melt-formed replica from the supply web. At completion of the melt-forming process step, the replica and transportable insert plate would be advanced to the next process step. The transportable insert assembly would provide mechanical stabilization and heat sinking for the thin polymeric web during subsequent processes, such as a deposition sequence as described U.S. patent application Ser. No. 10/185,246, filed on Jun. 26, 2002. In one embodiment, the exposed surface of the web would contain optical memory disk microstructure. The protected surface, that is in contact with the transportable insert, may also contain optical memory disk microstructure. The web-capturing insert would then be transported to a first vacuum deposition system in which at least one coating is deposited onto the exposed surface of the web polymer material to produce a coated polymer material. Then, the transportable insert plate and coated web polymer material exit the first vacuum deposition system. Next, the coated web polymer material is bonded to a carrier substrate (for example a 1.1 mm thick carrier substrate) to form a bonded assembly containing one fully coated optically memory disk information layer bonded to a stabilizing carrier substrate. At this time the bonded substrate assembly is released and removed from the transportable insert assembly. Bonded substrate assembly separation from the transportable insert may be facilitated by the use of retracting clamps, ejector pins, and/or an air ejection system. After separation, the transportable insert may be returned to the beginning of the process to participate in another replication cycle. Multiple transportable inserts may be utilized to improve work-flow. Next, the bonded substrate assembly is sent to a second vacuum deposition system in which at least one coating is deposited onto the substrate assembly. As in the embodiment utilizing the injection molded insert, the thickness of the bonded substrate assembly would provide mechanical stabilization and heat sinking during this vacuum deposition process. After the vacuum deposition process is complete, the bonded substrate assembly exits the second deposition system. Finally, the fully coated 2-layer disk is passed to a bonding unit where the required optical cover layer may be applied.

In one embodiment, the transportable insert(s) may be guided by a track, belt, chain, automated guide-way, or similar type device. The guiding system is used to move the transportable insert(s) between process steps. For example, the guiding system could be used to recycle a transportable insert to the beginning of the process where it would be aligned with and inserted into the opposing platen assembly to begin a replication cycle. Following the melt-forming replication step the guiding system would transport the capturing insert to a vacuum deposition system where at least one layer is deposited on to the exposed surface of the web. Preferably the vacuum deposition system incorporates gas gates to isolate the vacuum deposition system from pressure fluctuation associated with a traditional load-lock system. After the first vacuum deposition, the guiding system would transport the capturing insert to the remaining process stations in proper sequence (as described herein). Finally, the guiding system would return the transportable carrier to the beginning of the process to begin another replication cycle.

In another embodiment, the stamper insert plate assemblies are not transportable. In this embodiment the tooling may also cut the melt-formed replica from the supply web. The melt formed web, containing replicated microstructure on one or both sides, is selectively captured by one half of the opposing platen/stamper insert plate assembly. Transfer to the capturing half may be assisted through the use of ejector pins and/or an air ejection system. Next, a replica extraction tool moves into position over the captured replica, and the extracting tool presses against the exposed web polymer in the capturing carrier. While traditional handling methods may be employed, such as annular clamps, vacuum rings, or “suction cup” capturing devices, thin web may be difficult to properly handle in this manner. For this reason, methods that fully stabilize the thin web are preferred. Such methods typically require a large contact area that may include the sensitive replicated microstructure. Therefore, the extraction plate preferably has a self-cleaning compliant layer between the extracting plate and the melt formed polymer to protect the melt-formed image. Further, the compliant interface layer may be provided by a liquid or semi-liquid, in this way the risk of contamination and abrasion are reduced. For example, the compliant layer may be a solution, liquid, or semi-liquid selected from a group that includes various plasticizers and release agents, including stearyl alcohol, pentaerythritol tetrastearate. Further, the compliant layer may be provided by a solution of nitrocellulose or hydroxypropyl cellulose. Additionally, the compliant layer may be provided by a pressure sensitive adhesive. These and similar materials would facilitate temporary bonding to the web surface. After separation, residue could be easily removed from the web surface, for example by solvent rinsing and/or by vacuum plasma exposure. Materials that undergo a solid/liquid phase change below the glass transition temperature (T_{g}) of the web polymer may also be used to provide the compliant layer. Examples include various indium alloys and low molecular weight polymers. These materials may further contain additives that modify viscosity, wetting, and surface tension. For example, the substance would be heated to its liquid phase before contacting the web polymer and allowed to solidify after contact. In this way the replicated surface will adhere to the extractor plate without being damaged. The extraction mechanism of the removal tool may include mechanical adhesion, chemical adhesion, or a combination of both.

After the extraction plate has captured the web polymer, the web is released from the capturing stamper insert assembly. Controlled separation from the stamper insert assembly may be improved by the use of ejector pins and/or by injecting air between the stamper and web at an appropriate time in the process. Next, the extraction plate moves the melt-formed web polymer into a first vacuum deposition system in which at least one coating is deposited onto the polymer material to produce a coated polymer material. The extraction plate, being temporarily bonded to the surface of the web polymer, would provide mechanical stabilization and heat sinking for the thin polymeric web during subsequent vacuum deposition processes. After exiting the first deposition system, the coated polymer material is bonded to a substrate to form a substrate assembly, and the coated polymer material is released from the extraction plate through the selective application of heat-air injected into the interface between the web and extraction plate, peeling and/or controlled flexing of the structure. The bonded substrate assembly is next transported into a second vacuum deposition system in which at least one coating is deposited onto the substrate assembly. As in the embodiment utilizing the injection molded insert, the thickness of the bonded substrate assembly would provide mechanical stabilization and heat sinking during this vacuum deposition process. After exiting the said second vacuum deposition process chamber, the coated polymer material is bonded to an optical cover slip.

In a preferred embodiment hereof, stamper dimensional variation is limited by providing the stamper with a coefficient of thermal expansion (and contraction) substantially matched to that of the melt-formed web. Stamper thermal expansion and/or contraction may be controlled by any suitable means, such as by forming the stamper from a material or alloy having the desired coefficient of thermal expansion, forming the stamper as a multi-layered structure, etc. In another embodiment hereof, stamper dimensional variation may be reduced by limiting heat loss from the stamper to components of the web forming apparatus or the web or both. Heat loss may be limited in a number of ways including: The use of a thermal insulating layer(s) between the stamper and its backing carrier insert, the use of a thermal insulating layer(s) between the stamper carrier insert and its backing platen, providing a bias heat to the stamper carrier insert(s) and reducing the stamper contact time with the web. Additionally, the shrinkage of the melt-formed replica may be reduced by intentionally over-packing the melt-forming cavity formed between the two opposing platens. This may be accomplished by selecting a web thickness that exceeds the desired final melt-formed replica thickness and pressing this excess material into the cavity as the polymer cools. This is most easily accomplished in a configuration where the web is independently heated and/or heated and cooled from both sides of the melt-forming cavity. In this configuration the center of the web will cool more slowly than the interfaces with the stampers, allowing the more fluid central material to be packed into the space provided by normal polymer shrinkage. By matching the thermal expansion/contraction behavior of the stamper and melt-formed replica, reduced stamper/web differential motion can be provided to improve image fidelity and reduce surface stress in the polymeric film.

The contact time between the stamper(s) and the web is preferably 10 seconds or less, more preferably 3.0 seconds or less. When utilizing melt-forming process times of about 10 seconds or less, absorbed moisture in the polymer may be released and cause bubble formation. Therefore, the web may be pre-dried using an inline thermal drying tunnel, a microwave-drying tunnel, or other such drying device.

The stamper may be compressed against the web by any suitable press or pressing device. The press preferably delivers a pressure of 4000 PSI (pounds per square 1 inch) or less to the stamper/web contact zone. The melt-forming pressure in the replication zone is preferably in the range of 50 PSI to 2000 PSI.

Although the apparatus disclosed herein may have wide application in forming web material of all kinds, the web material is preferably a polymeric material of suitable optical, mechanical and thermal properties for making optical memory disks. Preferably, the web material is a thermoplastic polymer, such as polycarbonate, polycyclohexylethylene, poly methyl methacrylate, polyolefin, polyester, poly vinyl chloride, polysulfone, cellulosic substances, etc. The web material preferably has a refractive index suitable for use in optical memory disks (for example, 1.4 to 1.8). The web thickness is preferably about 0.02 mm to about 0.6 mm, depending upon the intended application. The invention of the current application is particularly useful for melt-forming a thin film, i.e. a web with a thickness of 0.25 mm or less. The web is preferably wide enough for replicating one, two, three, four, or more images across the web. The web material may contain one or more additives, such as antioxidants, UV absorbers, UV stabilizers, fluorescent or absorbing dyes, anti-static additives, release agents, fillers, plasticizers, softening agents, surface flow enhancers, etc. The web material is preferably a prefabricated roll, formed “off-line”, which may be supplied to the substrate forming apparatus at ambient temperature. Supplying the web material in the form of a roll to the system at ambient temperature allows for greater process flexibility and efficiency.

During operation, the web of polymeric film will be positioned across the open face of one or both of the carriers. Film thickness will be approximately equal to the gap formed between opposing surfaces of the carriers when the carriers are pressed together, although the film thickness may exceed the gap spacing in order to compensate for shrinkage. The opposing platens will then be positioned to press the carriers against one another in a manner that produces a precise, stable and reproducible alignment position. The heating system may be activated before and/or during the time the mating platens are pressed together. The heater may be any suitable heating device, such as a directed energy source, inductive heating source, resistive heating source, conductive heating source, radiating heating source, oscillating field, etc., or any combination or equivalent. Preferably, the stamper may be independently heated through any suitable means, such as induction heating, direct ohmic heating, contact heating, radiative heating, dielectric heating, etc., or any combination or equivalent. More preferably, the web may be independently heated through any suitable means, such as contact heating, dielectric heating, radiative heating, directed energy heating, etc., or any combination or equivalent.

Melt-flow formation is a process wherein the web material is heated to a relatively low viscosity and/or melted state, displaced, re-formed, and then allowed to stabilize. In melt-flow replication, the stamper(s) impinges upon the web as the web is heated to such a degree that the web material melts and/or locally flows. The combination of low stress material displacement and local flow allows the web to rapidly and accurately conform to the shape of the microstructure pattern on the stamper.

Although not desiring to be bound by theory, polymer response to a displacing force involves a viscous component and an elastic component. At T_{f} the viscous component dominates, and at T_{cold} (a temperature below T_{g}) the elastic component dominates. Above T_{g} (the glass transition temperature) a transition occurs where the increase in free volume allows rotational or translational molecular motion to take place. This freedom allows molecules to move past one another, causing viscous behavior to become more dominant. Embossing polymeric material at Tₛ or T_{soft} (a temperature below T_{f} but above T_{g}) requires substantial relaxation of strain before stamper separation. In comparison, various embodiments of the present invention contemplate melt-forming the disk substrate at T_{f} or above, and cooling the stamper/web laminate to below T_{f}, but not necessarily below T_{g}, before separation. While it is possible to reduce average thermal exposure by modifying the shape of the time/temperature profile to achieve extremely high peak temperature at the surface followed by a rapid cooling, this approach may have a practical limit imposed by the instability of certain polymers to excessively high peak temperature.

Although a wide range of temperature vs. time profiles can be achieved through the appropriate selection of materials, excessively high peak temperature is still undesirable. It has been found that melt flow formation may be more easily provided if the difference between T_{f} and T_{g} can be temporarily reduced without compromising the bulk physical properties of the web polymer. The selective addition of a flow enhancer to the web prior to melt-forming may reduce the required melt-forming peak temperature without compromising the bulk physical properties of the web polymer. To accommodate increasingly better flow dynamics without the undesired consequences of over heating, it has been found that additives to the web and/or web surface region to temporarily enhance flow characteristics may be used.

The web material is preferably provided with a flow enhancer. The flow enhancer may be any material or composition added to the web that provides enhanced flow characteristics over the basic web material under melt-flow conditions. The flow enhancer is preferably provided in an amount sufficient to reduce the dynamic viscosity of the web at a given temperature. Flow enhancer is preferably provided at 0.01 to 1.0% by weight in the web. Accordingly, the web material preferably has at least enough flow enhancer to lower T_{f} below reported values for dry or flow enhancer free material and is preferably provided in an amount sufficient to lower normal peak process temperature by 5% to 50%. By providing an amount of flow enhancer sufficient to modify the melt flow characteristics of the web, improved quality optical memory microstructures can be produced by melt-forming.

Flow enhancers, include plasticizers, resin emulsions, and release agents that are applied to the surface or integrated with the web in proper amounts. Preferred flow enhancers may include one or more compounds selected from the chemical families of fatty esters and fatty acids. A preferred flow enhancer includes the fatty ester, pentaerythritol tetrastearate. Preferably the flow enhancer provides properties suitable for temporarily lowering effective web T_{f} during the melt-forming process, and/or, as a result of process conditions, results in a permanent increase in web T_{g}.

In the platen press implementation of melt-flow replication, a substantial percentage (for example 50% or more) of the web cross section is heated to a temperature where it melts and/or flows. This additionally allows the web to be re-formed in the shape of the cavity formed between the opposing platens, and for web manufacturing defects to be reduced. In comparison, compression relaxation processes use force to distort and displace material for a time, at a temp below the melting and/or flow temperature that allows for relaxation of the strain generated in the web by the displacement forces.

FIG. 5 is a graphical illustration of the perpendicular birefringence in four individual 0.1 mm polycarbonate swatches between a pair of neutral glass slides as measured by a Dr. Schenk Prometeus MT136, which is a professional measuring and testing unit for data carriers. Peak 1 is a measurement of the perpendicular birefringence of a 0.1 mm polycarbonate swatch before being heated to the melt flow temperature (T_{f}) of the polycarbonate. Peaks 2-4 are measurements of the perpendicular birefringence of three 0.1 mm polycarbonate swatches after being heated to the melt flow temperature (T_{f}) of the polycarbonate throughout the entire thickness of the swatches. The individual peaks show that after heating the material to the melt flow temperature (T_{f}) of the polycarbonate, the perpendicular birefringence is reduced. This reduction in birefringence is particularly beneficial for optical recording media that may incorporate a blue ray disc, as discussed above.

In practice, web material 110 can be delivered to the melt-forming replication zone by any suitable web feed means. The means for feeding is preferably a device suitable for continuously delivering web material to the melt-forming zone accumulator, such as a sheet feed, folded material feed, roll feed, web extruder, etc. The web feed 102 is preferably a feed as shown in FIGS. 4a through 4c for feeding pre-manufactured rolls of polymeric web material to the melt-forming process zone. Depending on the specific implementation of the melt-forming process herein described, the web feed 102 may be complimented by a web take-up device located after the melt-forming zone accumulator, such as a take-up roll 402, for collecting the web 110 after processing or after formation, as illustrated in FIGS. 4a through 4c. Alternatively to using a take-up roll 402, the web may be cut into sections after formation or may be further processed into completed or partially completed optical memory disks. The roll 102 of polymeric web material is preferably supplied with a removable film or protective layer of material on one or both surfaces, such as a softer plastic film layer on the web. By using web having a softer protective layer, the web may be rolled, unrolled, and re-rolled with minimal to no surface scratching, which could otherwise affect the use of the web for optical memory devices. Depending on the characteristics of the protective layer and the exact implementation of the process, it may be removed before the melt-forming replication step. Alternatively, the protective layer may be selected to participate in the melt-forming process. Finally, depending on the exact implementation of the process, a protective coating may be re-applied after the melt-forming replication step.

While the invention has been illustrated in detail in the drawings and the foregoing description, the same is to be considered as illustrative and not restrictive in character as the present invention and the concepts herein may be applied to any formable material. It will be apparent to those skilled in the art that variations and modifications of the present invention can be made without departing from the scope or spirit of the invention. For example, the dimensions of the optical substrates, and the microstructures formed therein can be varied without departing from the scope and spirit of the invention. The materials used to construct the various elements used in the embodiments of the invention, such as the flat stamper(s), stamper support(s), stamper backing material, carrier insert(s), and the heating system, may be varied without departing from the intended scope of the invention. Furthermore, it is appreciated that the support for the platens, stamper carrier insert(s) and the stamper(s) could be integrated so as to provide one structure. Still further, it is appreciated that the present invention extends to embodiments that use optical memory substrates in any form, be that web, sheet, or otherwise. Further, by using one or more of the embodiments described above in combination or separately, it is possible to make optical memory disks having information and/or tracking structure that utilizes a web of polymeric material in a melt-forming process incorporating a substantially flat tool and/or stamper, reduce the effects of web surface defects and thickness variation, reduces birefringence artifacts resulting from the web manufacturing process, create a center hole through the web during the replication process, provide optimum cooling to minimize warp and replication process related birefringence, and that may also provide mechanical stability and heat sinking for the thin web during subsequent manufacturing steps. Thus, it is intended that the present invention cover all such modifications and variations of the invention, that come within the scope of the appended claims and their equivalents.

We claim:

1. A method of forming a microstructure image on the surface of polymeric material having a melt flow temperature (T_{f}) and a glass transition temperature (T_{g}) comprising the steps of:
providing a web of polymeric material;
adapting the web of polymeric material to flow into a replication zone between a first platen and a second platen, at least one of said first platen and said second platen having a stamper, said stamper having at least one microstructure image;
heating the web of polymeric material to at least the melt flow temperature (T_{f}) during said forming; and
melt-forming said microstructure image on the polymeric material with said stamper to produce a melt formed image.

2. The method of claim 1, further comprising heating said stamper.

3. The method of claim 2, said polymeric material having a pre melt-forming perpendicular birefringence and a post melt-forming perpendicular birefringence, wherein the post melt-forming perpendicular birefringence is lower than the pre melt-forming perpendicular birefringence.

4. The method of claim 3, said web of polymeric material having a cross section between the microstructure image and one of said first platen and said second platen, wherein said heating the web of polymeric material comprises heating the cross section to at least the melt flow temperature (T_{f}).

5. The method of claim 1, wherein said heating the web of polymeric material reduces the perpendicular birefringence of the polymeric film having the melt formed image.

6. The method of claim 1, further comprising the step of introducing a flow enhancer, wherein said flow enhancer reduces the melt flow temperature (T_{f}) and the glass transition temperature (T_{g}).

7. The method of claim 6, wherein the web of polymeric material includes water in an amount sufficient to enhance surface flow during said melt-forming.

8. The method of claim 4, wherein the temperature of the heated stamper is above the melt flow temperature (T_{f}) of the polymeric material when contacting the web.

9. The method of claim 1, further comprising the step of separating the stamper from the web when the surface of the web is at a temperature between the melt flow temperature (T_{f}) and the glass transition temperature (T_{g}).

10. The method of claim 1, said polymeric material selected from the group consisting of polycarbonate, poly methyl methacrylate, polyolefin, polyester, poly vinyl chloride, polysulfone.

11. The method of claim 10, said polymeric material having a thickness of 0.25 mm or less.

12. The method of claim 1, said stamper attached to said first platen and a transportable insert removably secured into said second platen further comprising:
capturing said melt formed image on said transportable insert;
transporting said transportable insert into a first evacuable deposition chamber;
depositing at least one coating onto said melt formed image to produce a coated melt formed image; and
transporting said transportable insert from said first evacuable deposition chamber.

13. The method of claim 12, wherein said transportable insert is a heat sink and mechanical stabilizer.

14. The method of claim 13 further comprising:
bonding said coated melt formed image to a substrate to form a substrate assembly; and
releasing said coated melt formed image from said transportable insert.

15. The method of claim 14 further comprising:
transporting said substrate assembly into a second evacuable deposition chamber;
depositing at least one coating onto said substrate assembly to produce a twice coated polymeric material; and
exiting said second deposition chamber

16. The method of claim 15 further comprising:
bonding said twice coated polymer material to an optical cover slip.

17. The method of claim 1, said stamper attached to said first platen and a coated carrier insert removably secured into said second platen.

18. The method of claim 17, said coated carrier comprising an injection molded polymer carrier having a track microstructure coated with a reflective metal layer, a first dielectric layer, an active recording layer, and a second dielectric layer.

19. The method of claim 18, further comprising bonding said coated polymer material to an optical cover slip.

20. The method of claim 19, wherein said carrier plate is a heat sink.

21. The method of claim 1, further comprising:
capturing said polymeric material on a capturing carrier, wherein said capturing carrier comprising one of said first platen and said second platen;
extracting said polymeric material from said capturing carrier;
transferring said polymeric material to a carrier plate;
transporting said carrier plate into a first evacuable deposition chamber;
depositing at least one coating onto said polymeric material to produce a coated polymeric material; and
transporting said carrier plate from said first evacuable deposition chamber.

22. The method of claim 21, further comprising:
bonding said coated polymeric material to a substrate to form a substrate assembly; and
releasing said coated polymeric material from said capturing carrier.

23. The method of claim 22, further comprising:
transporting said substrate assembly plate into a second evacuable deposition chamber;
depositing at least one coating onto said substrate assembly; and
exiting said second deposition chamber

24. The method of claim 23, further comprising:
bonding said coated polymer material to an optical cover slip.

25. The method of claim 21, wherein said carrier plate is a heat sink.

26. The method of claim 21, said extracting comprising:
pressing an extracting plate against said polymer material on a side opposite the capturing carrier, said extraction plate having a compliant layer between said extracting plate and said polymer material.

27. The method of claim 26, wherein said compliant layer is an indium alloy having a melting point below the glass transition temperature of said polymer material, wherein said indium alloy contacts said extraction plate as a liquid and said indium alloy liquid solidifies as cooled.

28. The method of claim 26, wherein said compliant layer is selected from the group consisting of stearyl alcohol, pentaerythritol tetrastearate, nitrocellulose and hydroxypropyl cellulose.

29. The method of claim 21, said extracting comprising:
pressing an extracting plate against said polymer material on a side opposite the capturing carrier, said extraction plate having a compliant layer between said extracting plate and said polymer material.

30. The method of claim 26, wherein said compliant layer is an indium alloy having a melting point below the glass transition temperature of said polymer material, wherein said indium alloy contacts said extraction plate as a liquid and said liquid solidifies as cooled.

31. The method of claim 1, further comprising the step of drying said polymeric material before said melt-forming.

32. The method of claim 1, said melt-forming having a time duration of about 3 seconds to about 10 seconds.

33. The method of claim 1, said embossing having a time duration of about 3 seconds.

34. The method of claim 1, further comprising the step of stabilizing the web of polymeric material in the replication zone during said melt-forming.

35. The method of claim 34, wherein said stabilizing of the web includes increasing slack in the web of polymeric material flowing toward the replication zone as the stamper contacts the web of polymeric material and decreasing slack in the web of polymeric material flowing away from said replication zone as the stamper contacts the web of polymeric material.

36. The method of claim 35, wherein said stabilizing further includes decreasing slack in the web of polymeric material as the web of polymeric material flows into the replication zone and increasing slack in the web of polymeric material as the web of polymeric material flows out of the replication zone.

37. The method of claim 36, wherein said stabilizing includes a first piston decreasing and increasing slack upstream from said replication zone and a second piston increasing and decreasing slack downstream from said replication zone.

38. The method of claim 37, said first piston increasing slack in the web of polymeric material flowing toward the replication zone as the stamper contacts the web of polymeric material and decreasing slack in the web of polymeric material as the web of polymeric material flows into the replication zone and said second piston decreasing slack in the web of polymeric material flowing away from said replication zone as the stamper contacts the web of polymeric material and increasing slack in the web of polymeric material as the web of polymeric material flows out of the replication zone.

39. The method of claim 1, further comprising creating a hole in the web of polymeric material during said melt-forming.

40. The method of claim 39, said creating a hole comprising punching said hole with a punch nip set in either said first platen and said second platen.

41. The method of claim 39, said means for punching a hole comprising punching said hole with a retractable hole puncher set in either of said first and second platen.

42. The method of claim 38, said first piston having a first roller adapted to limit damage as said web of polymeric material flows across the first piston and said second piston having a second roller adapted to limit damage as the web of polymeric material flows across the second piston.

43. The method of claim 1, at least one of said first platen and said second platen having at least one guide roller upstream from the replication zone adapted to limit damage as the web of polymeric material flows into the replication zone.

44. The method of claim 44, at least one of said first platen and said second platen having at least one guide roller downstream from the replication zone adapted to limit damage as the web of polymeric material flows out from the replication zone.

45. The method of claim 1, both of said first and second platens having a microform image, wherein the first platen microform image and the second platen microform image are simultaneously melt-formed onto opposing sides of said web of polymeric material.

46. The method of claim 45, further comprising the step of drying said polymeric material before said melt-forming.

47. The method of claim 1, said stamper having a substantially flat surface.

48. The method of claim 1, said stamper having a domed shaped prior to contact with the web and a substantially flat surface during said melt-forming.

49. The method of claim 34, wherein said stabilizing of the web comprises stopping the flow of said web into and out of the replication zone during said melt-forming.

50. The method of claim 1, further comprising the step of drying said polymeric material before said melt-forming.
